(19) United States
(12) Patent Application Publication
(10) Pub. No.: US 2014/0220211 A1
(43) Pub. Date: Aug. 7, 2014

(54) METHOD FOR PRODUCING BEVERAGES

(71) Applicants: Yann Brunner, Nuvilly (CH); Michael (Mischa) Stieger, Orbe (CH)

(72) Inventors: Yann Brunner, Nuvilly (CH); Michael (Mischa) Stieger, Orbe (CH)

(73) Assignee: NESTEC S.A., Vevey (CH)

(21) Appl. No.: 14/343,208

(22) PCT Filed: Sep. 5, 2012
(86) PCT No.: PCT/EP12/67248

§ 371 Date: Mar. 6, 2014

(30) Foreign Application Priority Data
Sep. 6, 2011 (EP) 11180253.4

(51) Int. Cl. A23L 2/385

(52) U.S. Cl. CPC A23L 2/385
USPC 426/519

(57) ABSTRACT

The invention concerns a method for producing beverages by mixing a beverage concentrate powder (2) with a diluent in a receptacle (1), comprising the steps of successively: 1) delivering a dose of beverage concentrate powder in the receptacle, 2) introducing a dose of diluent in the receptacle,

### FIELD OF THE INVENTION

The present invention relates to a method for producing beverage from soluble beverage powders.

### BACKGROUND OF THE INVENTION

A beverage dispenser is a device that prepares a beverage from one or more beverage ingredients by having the ingredients interact with a liquid. In some types of beverage dispensers, beverage sources that include concentrates and/or powders are mixed with a liquid, such as water for example, in order to prepare a beverage. Thereby, in particular in the field of hot beverages such as coffee, tea, hot chocolate or soup, powders are used for the preparation of the beverage.

The known beverage dispensers therefore comprise a dosing device for dosing a predefined amount of soluble powder stored in a storage chamber into a mixing chamber or into a dedicated vessel. Therein, liquid can be introduced in order to interact with the soluble powder and hence, form a food composition.

The present invention particularly relates to dispensers in which the soluble powder is mixed with the liquid in the drinking cup and not in a mixing chamber. In such dispensers, the powder is usually metered by the dosing device and delivered to the drinking cup. Liquid is simultaneously or successively fed to the drinking cup so that dissolution occurs. However, the existing beverage preparation devices which make use of the above outlined principle suffer the inconvenience that the beverage concentrate is not fully dissolved and thus, residua of the concentrate are present in the prepared beverage. This leads to a non-uniform and thus to a non-inviting appearance of the prepared beverage. In addition, during provision of beverage concentrate to a receptacle, parts of the concentrate may stick to the inner side walls of the receptacle and can thus not be fully dissolved in the beverage preparation method. Moreover, if the beverage concentrate is not fully dissolved in the liquid provided to the receptacle, the taste of the beverage may vary from the intended beverage taste. Hence, it is desired to have a reproducible strength respectively concentration of the beverage to be prepared, wherein the concentration of the beverage corresponds to the amount of beverage concentrate provided to the receptacle and does not vary for each preparation. Therefore, a device for the preparation of a beverage according to the above stated principle is sought-after, which enables a full dissolution of the whole amount of beverage concentrate provided to the receptacle.

Different solutions (for example WO 2010/034722) have been proposed to solve the above issues, all of them consisting in delivering the diluent according to a specific movement in the receptacle containing the beverage concentrate powder.

The aim of the present invention is to provide a method for allowing an efficient beverage preparation on the basis of beverage concentrate powder provided to a receptacle which is mixed with a diluent in the receptacle.

### SUMMARY OF THE INVENTION

According to a first aspect, the invention concerns a method for producing beverages by mixing at last one beverage concentrate powder with a diluent in a receptacle, comprising the steps of successively:
1) delivering a dose of at least one beverage concentrate powder in the receptacle,
2) introducing a dose of diluent in the receptacle,
   wherein during step 1) the powder is delivered according to a rotating movement with respect to the receptacle.

The present invention relates to a method for preparing beverages from a beverage powder concentrate. In the present specification the term “powder” relates to a bulk beverage ingredient that covers any free flowing solid product like dust, fine grains, loose particles, agglomerates, granules. According to the preferred mode, the beverage concentrate powder can be soluble powder of coffee, tea, chocolate, milk, soup, . . .

According to the method of the present invention, in a first step, a dose of powder is introduced in a receptacle and, in a second different step, a dose of diluent is introduced in the receptacle and mixed with the powder. The receptacle is generally the drinking cup. Consequently the beverage is prepared directly in the receptacle and not in a mixing device of the dispenser. The receptacle preferably presents a frustoconical shape although other shapes could be used. According to the invention, during this first step of introduction of the powder in the receptacle, the powder is delivered according to a rotating movement with respect to the receptacle. This movement can be obtained either by rotating the receptacle during the first step or by rotating the means for delivering the powder during the first step. Due to this rotating movement of the powder with respect to the receptacle during delivery, the powder spreads out on the whole surface of the receptacle bottom.

According to the preferred embodiment of the present invention, the receptacle is rotated during the delivery of the dose of beverage concentrate powder.

Preferably the receptacle rotates all along the time during which the powder flows in the receptacle.

Generally, the receptacle rotates along a vertical axis going through its bottom centre during the delivery of the dose of beverage concentrate powder.

Preferably the dose of beverage concentrate powder is delivered on the receptacle bottom at a position different from the centre of the receptacle.

According to a first mode of the preferred embodiment, the dose of beverage concentrate powder can be delivered on the receptacle bottom at a position between the centre of the bottom and the edge of the bottom. Preferably the receptacle moves only in rotation. Consequently, the powder falls according to a circular movement relative to the cup bottom. Preferably the rotation of the receptacle and the flow of powder are configured so that the cup makes at least one rotation, even more preferably more than one rotation, during the delivery of the powder.

According to a second mode of the preferred embodiment, the receptacle can be horizontally displaced during the delivery of the dose of beverage concentrate powder. Consequently, according to this second mode, the receptacle simultaneously rotates and horizontally moves. Preferably the receptacle is horizontally displaced so that the dose of beverage concentrate powder is delivered on the receptacle bottom on a path extending between the centre of the bottom and the edge of the bottom. Consequently, the powder falls according to a spiral movement relative to the cup bottom. Preferably the rotation of the receptacle and the horizontal displacement of the receptacle are configured so that the receptacle bottom centre moves along a distance d equal to the distance between the centre of the receptacle bottom and the edge of the receptacle bottom during at least one rotation.

According to a less preferred embodiment of the present invention, during the first step the means for delivering the powder is rotated during the process first step. In this embodiment the receptacle is immobile and the means for delivering the powder rotates with respect to the receptacle.

Generally during step 2) the dose of diluent is introduced in the receptacle by directing at least one jet of diluent to an inner bottom portion of the receptacle and at least one jet of diluent to an inner side wall portion of the receptacle. Preferably at least two jets of diluent are directed to an inner bottom portion of the receptacle and at least two jets of diluent are directed to an inner side wall portion of the receptacle and wherein the at least two jets of diluent directed to the inner bottom portion of the receptacle and respectively the at least two jets of diluent directed to the inner side wall portion of the receptacle are arranged at different angles (α, β) with respect to the vertical. Preferably the receptacle is rotated during the introduction of the diluent. According to the preferred embodiment, the method for injecting diluent described in WO 2010/034722 is implemented.

Generally in the method of the present invention the receptacle is positioned on support means before the first step. The support enables the correct positioning of the receptacle in the dispenser implementing the method in view of the relative position of the means for delivering the powder and the receptacle and in view of the rotation means.

### BRIEF DESCRIPTION OF THE DRAWINGS

The characteristics and advantages of the invention will be better understood in relation to

FIGS. 1a, 1b and 1c illustrate the different steps of preparation of a beverage according to the first mode of the preferred embodiment of the present invention,

FIGS. 2a, 2b depict the top view of the receptacle between the steps illustrated in FIGS. 1a and 1b,

FIGS. 3a, 3b and 3c illustrates the difference steps of preparation of a beverage according to the second mode of the preferred embodiment of the present invention,

FIGS. 4a, 4b depict the top view of the receptacle between the steps illustrated in FIGS. 3a and 3b.

FIG. 5 illustrates the shape of a beverage concentrate powder delivered in a cup according to the invention and according to the state of the art.

### DETAILED DESCRIPTION OF THE DRAWINGS

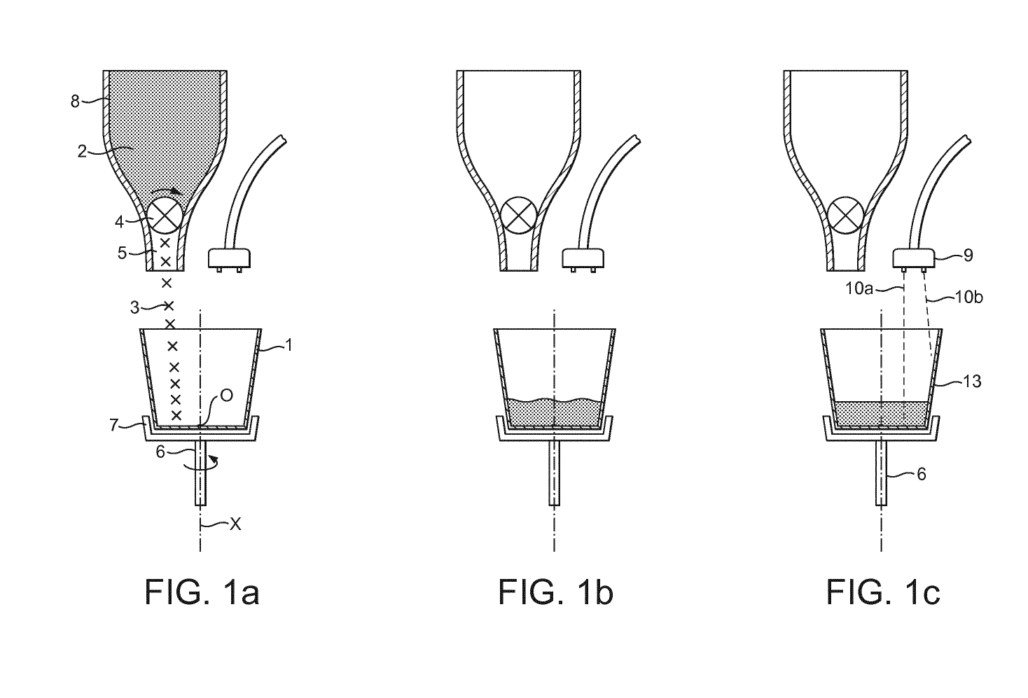

FIGS. 1a, 1b and 1c illustrate the different steps of preparation of a beverage with a dispenser comprising means 8 for storing a beverage concentrate powder 2 and means 4 for dosing a dose of the powder from said storing means and delivering it to a receptacle 1 e.g. through a chute 5. The receptacle is placed on means 6 configured for rotating the receptacle 1. The position of the receptacle 1 is controlled through means 7 for positioning the receptacle. This means enables the positioning of the receptacle:
relative to the chute outlet so that the powder falling from the chute reaches the bottom 11 of the receptacle at a position between the centre of the bottom O and the edge 12 of the bottom.
relative to the rotating means so that the axis of rotation X of said rotating means goes through the bottom centre O of the receptacle during the delivery of the dose of beverage concentrate powder.

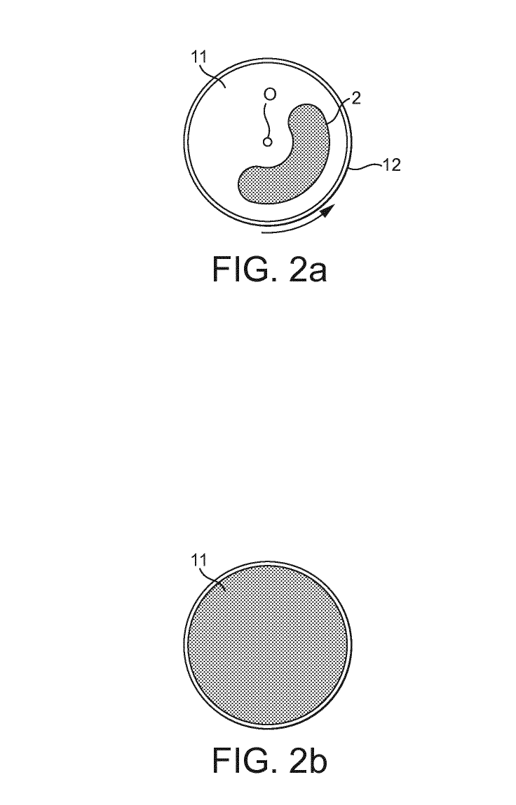

FIG. 1a illustrates the first step of the preferred embodiment of the present invention during which a dose of beverage concentrate powder 2 is delivered in the receptacle 1. While the dosing means 4 is activated and the powder flows through the chute 5 in direction of the empty receptacle 1, the rotating means 6 is activated so that the receptacle 1 rotates along the vertical axis X going through its bottom centre O. Due to the rotation during the first step the powder flow 3 draws a circle on the bottom 11 of the receptacle as illustrated in FIG. 2a. Due to the rotation, the powder is uniformly distributed at the bottom of the receptacle at the end of the first step as illustrated in FIGS. 1b and 2b.

FIG. 1c illustrates the second step during which a dose of diluent is introduced in the receptacle. The diluent is introduced through a nozzle 9 that preferably delivers 2 jets of diluent 10a, 10b in the receptacle, one 10b being oriented to an inner side wall portion 13 of the receptacle and the other 10a being directed to the inner bottom portion 11 of the receptacle. Preferably the rotating means 6 can be activated during the second step of introduction of the diluent.

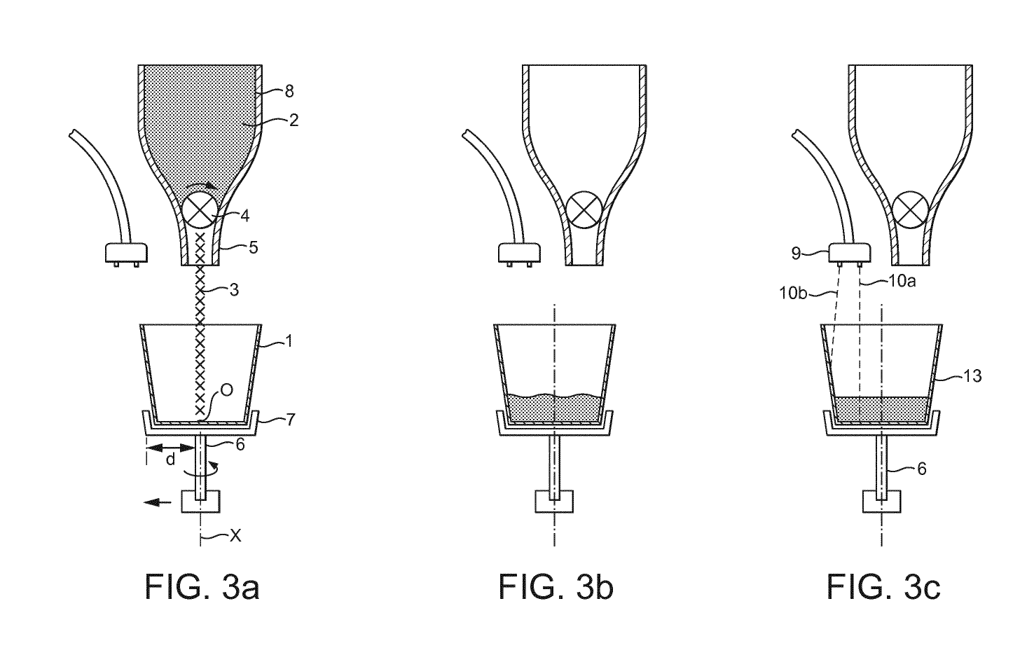

FIGS. 3a, 3b and 3c illustrate the different steps of preparation of a beverage with a dispenser such as described in FIG. 1a implementing the preferred embodiment of the method of the present invention according to a second mode. FIG. 3a illustrates the first step of the method during which a dose of beverage concentrate powder 2 is delivered in the receptacle 1. While the dosing means 4 is activated and the powder flows through the chute 5 in direction of the empty receptacle 1, the rotating means 6 is activated so that simultaneously:
the receptacle 1 rotates along the vertical axis X going through its bottom centre O, and
the receptacle 1 is horizontally displaced during the delivery of the powder.

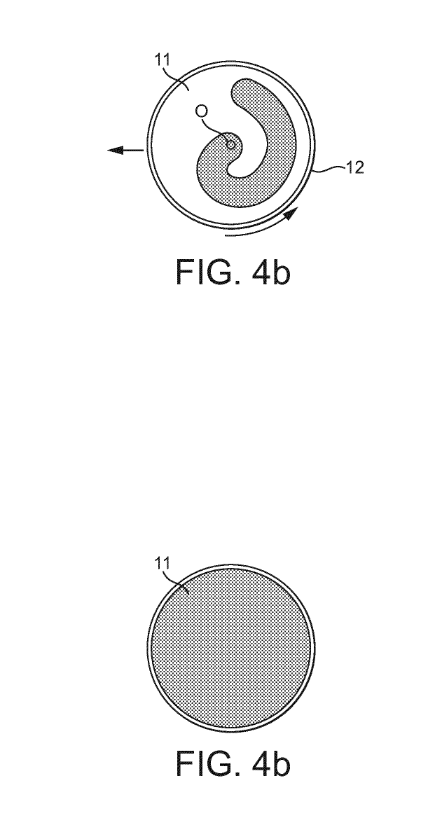

The receptacle is displaced so that the powder is delivered on the receptacle bottom 11 on a path extending between the centre of the bottom and the edge of the bottom. As can be seen on FIG. 3a showing the state of the receptacle at the beginning of the first step and FIG. 3b showing the state of the receptacle at the end of the first step, the receptacle 1 moves horizontally so that the outlet of the chute 5 initially faces the centre O of the receptacle bottom 11 and finally almost faces the edge 12 of the receptacle bottom. Besides due to the rotation during the first step the powder draws a spiral on the bottom 11 of the receptacle as illustrated in FIG. 4a. The powder is uniformly distributed at the bottom of the receptacle at the end of the first step as illustrated in FIGS. 3b and 4b. FIG. 3c illustrates the second step during which a dose of diluent is introduced in the receptacle and is implemented as in FIG. 1c.

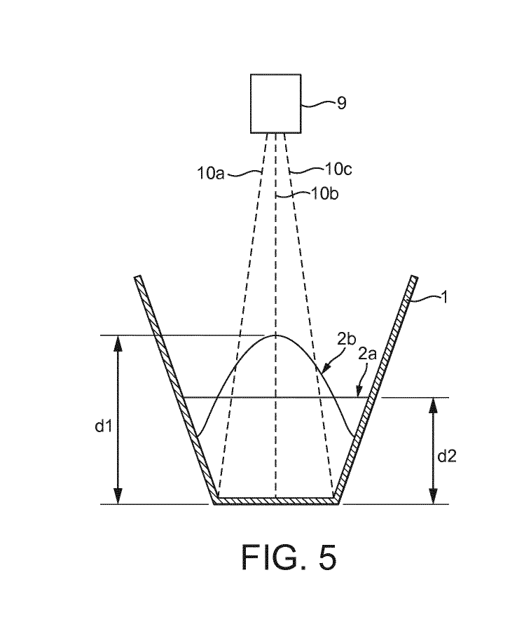

FIG. 5 describes the shape 2a of the beverage concentrate powder delivered in the cup 1 according to the invention and the shape 22 of the beverage concentrate powder delivered in the cup according to the state of the art (that is without rotation of the powder relative to the cup during powder dispensing in the cup). Whereas in the state of the art the powder has the form of a hill, the powder is relatively flat with the dispensing process of the present invention. This difference of shape influences the dissolution step when the 3 diluent jets 10a, 10b, 10c are introduced in the cup 1. In the process of the present invention, the 3 diluent jets impact the powder at the same distance d₂ from the bottom of the cup and the agitation of the beverage is homogeneous, whereas in the state of the art, the 3 jets impact the powder at different distances comprised between d₁ and d₂ from the bottom of the cup, consequently the jets mixes differently and projects powder on the lateral sides of the cup, initiating the formation of lumps in the final beverage.

The method of the present invention presents the advantage of improving the dissolution of a powder in a drinking cup with diluent jets.

1. A method for producing beverages by mixing at least one beverage concentrate powder with a diluent in a receptacle, comprising the steps of successively:
delivering a dose of beverage concentrate powder in the receptacle; and
introducing a dose of diluent in the receptacle,
wherein the powder is delivered according to a rotating movement with respect to the receptacle.

2. A method according to claim 1, wherein the receptacle is rotated during the delivery of the dose of beverage concentrate powder.

3. A method according to claim 2 wherein the receptacle is rotated along a vertical axis going through its bottom center during the delivery of the dose of beverage concentrate powder.

4. A method according to claim 2 wherein the dose of beverage concentrate powder is delivered on a receptacle bottom at a position different from the center of the receptacle.

5. A method according to claim 4 wherein the dose of beverage concentrate powder is delivered on the receptacle bottom at a position between the center of the bottom and the edge of the bottom.

6. A method according to claim 4 wherein the rotation of the receptacle and the flow of powder are configured so that the receptacle makes at least one rotation during the delivery of the powder.

7. A method according to claim 2 wherein the receptacle is horizontally displaced during the delivery of the dose of beverage concentrate powder.

8. A method according to claim 7 wherein the receptacle is horizontally displaced so that the dose of beverage concentrate powder is delivered on the receptacle bottom on a path extending between the center of the receptacle bottom and the edge of the receptacle bottom.

9. A method according to claim 8 wherein the rotation of the receptacle and the horizontal displacement of the receptacle are configured so that the receptacle bottom center moves along a distance equal to the distance between the center of the receptacle bottom and the edge of the receptacle bottom during at least one rotation.

10. A method according to claim 1 wherein the dose of diluent is introduced in the receptacle by directing at least one jet of diluent to an inner bottom portion and at least one jet of diluent to an inner side wall portion of the receptacle.

11. A method according to claim 1 wherein at least two jets of diluent are directed to an inner bottom portion of the receptacle and at least two jets of diluent are directed to an inner side wall portion of the receptacle and wherein the at least two jets of diluent directed to the inner bottom portion of the receptacle and respectively the at least two jets of diluent directed to the inner side wall portion of the receptacle are arranged at different angles with respect to the vertical.
